(19) United States
(12) Patent Application Publication
(10) Pub. No.: US 2026/0267319 A1
(43) Pub. Date: Sep. 10, 2026

(54) INBOUND CHEMICAL PRODUCT WITH ENVIRONMENTAL ATTRIBUTES

(71) Applicant: BASF SE, Ludwigshafen am Rhein (DE)

(72) Inventors: Andreas WOLLNY, Ludwigshafen (DE); Michael PRINZ, Ludwigshafen (DE); Georg Arnold KREI, Ludwigshafen (DE); Nicole GRAF, Ludwigshafen (DE)

(21) Appl. No.: 18/722,572

(22) PCT Filed: Dec. 19, 2022
(86) PCT No.: PCT/EP2022/086671

§ 371 Date: Jun. 21, 2024

Related U.S. Application Data
(60) Provisional application No. 63/416,091, filed on Oct. 14, 2022.

(30) Foreign Application Priority Data
Dec. 21, 2021 (EP) 21216268.9
Dec. 21, 2021 (EP) 21216269.7
Dec. 21, 2021 (EP) 21216270.5
Dec. 21, 2021 (EP) 21216271.3
Dec. 21, 2021 (EP) 21216286.1
Dec. 21, 2021 (EP) 21216292.9
Dec. 21, 2021 (EP) 21216326.5
Dec. 21, 2021 (EP) 21216327.3
Dec. 21, 2021 (EP) 21216333.1
Apr. 4, 2022 (EP) 22166573.0
Apr. 12, 2022 (EP) 22167945.9
May 10, 2022 (EP) 22172609.4
May 10, 2022 (EP) 22172611.0
May 10, 2022 (EP) 22172615.1
May 10, 2022 (EP) 22172617.7
May 10, 2022 (EP) 22172619.3
Sep. 9, 2022 (EP) 22194793.0
Sep. 9, 2022 (EP) 22194800.3
Sep. 9, 2022 (EP) 22194808.6
Sep. 9, 2022 (EP) 22194815.1
Sep. 9, 2022 (EP) 22194818.5
Oct. 14, 2022 (EP) 22201672.7
Oct. 18, 2022 (EP) 22202183.4
Dec. 5, 2022 (EP) 22211421.7

(51) Int. Cl. G05B 19/418

(52) U.S. Cl. CPC G05B 19/41865

(57) ABSTRACT

Disclosed are computer-implemented method for registering at least one input material associated with at least one environmental attribute, a method for producing at least one output material associated with at least one environmental attribute and associated apparatuses.

### TECHNICAL FIELD

The present disclosure relates to an apparatus configured to assign at least one environmental attribute associated with input material(s) to target material(s) and a computer-implemented method for assigning at least one environmental attribute associated with input material(s) to target material(s).

### TECHNICAL BACKGROUND

In supply chains the environmental impact of each supply chain participants is of great interest. Transparency between the participants can aid collective reduction of environmental impacts to combat climate change. However, data sharing of environmental impact data is hindered by the lack of common data standards and the lack of trusted data platforms. In addition, the highly specific and centralized setup of data systems today makes exchange and sharing for collective action laborious. Hence there is a need to develop metrices quantifying the environmental impact, to simplify data standards relating to environmental impact and to broadly enable a secure exchange of supply chain data relating to the environmental impact.

### SUMMARY OF THE INVENTION

Disclosed is in one aspect a computer-implemented method for registering at least one input material associated with at least one environmental attribute, wherein the input material is used in a chemical production network deriving one or more output material(s) from the input material, the method comprising:
providing an input material to the chemical production network,
providing at least one input material identifier associated with the respective input material, at least one environmental attribute associated with the respective input material and an quantity of input material provided to the chemical production network, based on the quantity of input material allocating the environmental attribute to an input material account associated with the respective environmental attribute.

Disclosed is in another aspect a method for producing at least one output material associated with at least one environmental attribute, wherein the output material is produced by a chemical production network from one or more input material(s), the method comprising:
producing the output material at least in part from the one or more input material(s),
providing an output material identifier associated with the produced output material,
linking one or more environmental attribute from at least one input material account associated with the respective environmental attribute to the output material identifier, wherein the input material account includes environmental attribute(s) registered on entry of one or more input material(s) associated with at least one environmental attribute according to any of the methods disclosed herein,
providing the output material associated with at least one environmental attribute.

Disclosed is in another aspect a method for producing at least one output material associated with at least one environmental attribute, wherein the output material is produced by a chemical production network from one or more input material(s), the method comprising:
producing the output material at least in part from the one or more input material(s),
providing the output material identifier associated with the produced output material,
linking one or more environmental attributes from the at least one input material account associated with the respective environmental attribute to the output material identifier, wherein the input material account is associated with the respective environmental attribute and holds environmental attributes, which are allocated to the input material account based on input material provided to the chemical production network, e.g. for production of the output material,
providing the output material associated with at least one environmental attribute.

Disclosed is in another aspect an apparatus configured to register at least one input material associated with at least one environmental attribute, wherein the input material is used in a chemical production network deriving one or more output material(s) from the input material, the method comprising:
a material provider an input material to the chemical production network,
an identifier provider configured to provide at least one input material identifier associated with the respective input material, at least one environmental attribute associated with the respective input material and an quantity of input material provided to the chemical production network,
an inbound allocator configured to allocate based the quantity of input material the environmental attribute to an input material account associated with the respective environmental attribute.

Disclosed is in another aspect an apparatus configured to produce at least one output material associated with at least one environmental attribute, wherein the output material is produced by a chemical production network from one or more input material(s), the method comprising:
an apparatus configured to register one or more input material(s) associated with at least one environmental attribute according to the apparatus disclosed herein or the apparatus performing the methods disclosed herein,
a chemical production network configured to produce the output material at least in part from the one or more input material(s),
a identifier provider configured to provide an output material identifier associated with the produced output material,
a linker configured to link one or more environmental attributes from the at least one input material account associated with the respective environmental attribute to the output material identifier,
a material provider configured to provide the output material associated with at least one environmental attribute.

Disclosed in another aspect is an apparatus configured to produce at least one output material associated with at least one environmental attribute, wherein the output material is produced by chemical production network from one or more input material(s), the method comprising:
a chemical production network configured to produce the output material at least in part from the one or more input material(s),
a identifier provider configured to provide an output material identifier associated with the produced output material,
a linker configured to link-one or more environmental attributes from the at least one input material account associated with the respective environmental attribute to the output material identifier, wherein the input material account is associated with the respective environmental attribute and holds environmental attributes, which are allocated to the input material account based on input material provided to the chemical production network
a material provider configured to provide the output material associated with at least one environmental attribute.

In yet another aspect disclosed is a computer element, in particular a computer program product or a computer readable medium, with instructions, which when executed on one or more computing node(s) are configured to carry out the steps of any of the methods disclosed herein or which when executed on one or more computing node(s) are configured to be carried out by the apparatuses disclosed herein.

### EMBODIMENTS

Any disclosure and embodiments described herein relate to the methods, the apparatuses, the computer elements and uses lined out above or below and vice versa. The benefits provided by any of the embodiments and examples equally apply to all other embodiments and examples and vice versa.

As used herein “determining” also includes “initiating or causing to determine”, “generating” also includes “initiating and/or causing to generate” and “providing” also includes “initiating or causing to determine, generate, select, send and/or receive”. “Initiating or causing to perform an action” includes any processing signal that triggers a computing node or device to perform the respective action.

The methods, apparatuses and computer elements disclosed herein provide an efficient way to provide chemical products with positive environmental impact in the value chain. By registering environmental attributes to input material accounts on entry into the chemical production network, environmental attributes associated with input materials can be efficiently allocated and managed. By allocating the environmental attributes based on the quantity of input material, the environmental contribution to the chemical production network can be tracked according to the physical stream of input materials into the chemical production network. Specifically for chemical networks that produce more than one output material from more than one input material via interconnected and non-connected production chains, the registration of respective input materials allows to flexibly adjust the allocation mechanisms in line with the physical setup of the chemical production network. The use of input material accounts further allows to abstract the complexity of chemical production networks while still allowing to assign environmental impact to output material(s). This way the environmental impact of produced chemicals can be determined in line with the physical set up of the chemical production network. Moreover, the environmental attribute of the input materials used in the chemical production network can be made transparent and used in the further processing to output materials.

The quantity of input material(s) may include the mass, weight, molecular weight, volume, energy equivalent, e.g. Lower Heating Value (LHV) or Higher Heating Value (HHV), atom equivalents, e.g. methane, carbon, hydrogen equivalents. The quantity of input material(s) may relate to the amount of input material(s).

The input material may comprise any input material entering the chemical production network at any entry point. The input material may include a chemical product such as a natural, organic or inorganic chemical product. The input material may be a pre-cursor product, an intermediate material or a raw material used to produce one or more output materials. The input material may be fed to the chemical production network to produce one or more output materials. The input material may be fed to chemical production network including one or more production chains with multiple process steps. The input material may be fed to the chemical production network at the start of the production chain or at any intermediate stage of the production chain. The input materials entering the chemical production network may be used to produce one or more output materials.

The input material identifier may comprise any identifier uniquely associated with the input material. The input material identifier may be associated with the physical entity of the input material. The input material identifier may refer to a single batch of input material. The input material identifier may be associated with a group of input materials. The identifier may refer to multiple physical entities of the input material. The input material identifier may be associated with continuous or semi-continuous steam of input material. The identifier may refer to a stream of the input material e.g. over a certain time period or from a certain supplier.

The output material may include or be any material produced by the chemical production network using at least one input material. The output material may comprise or be any output material leaving the chemical production network at any exit point. The output material may comprise any chemical product obtained from chemical reactions as well as natural chemical products. Natural chemical products may encompass any chemical substance that is naturally occurring, i.e. any unprocessed chemical substance that is found in nature, such as chemicals from plants, micro-organisms, animals, the earth and the sea or any chemical substance that is found in nature and extracted using a process that does not change its chemical composition. Natural chemical products may include biologicals like enzymes as well naturally occurring inorganic or organic chemical products. Natural chemical products can be isolated and purified prior to their use or they can be used in unisolated and/or unpurified form. Chemical products obtained from chemical reactions may be any inorganic or organic chemical product obtained by reacting inorganic and/or organic chemical reactants. The inorganic and organic chemical reactants may be naturally occurring chemical products or can be chemical products obtained from chemical reactions. Chemical reactions may include any chemical reaction commonly known in the state of the art in which the reactants are converted to one or more different chemical products. Chemical reactions may involve the use of catalysts, enzymes, bacteria, etc. to achieve the chemical reaction between the reactants.

The output material identifier may comprise any identifier uniquely associated with the output material. The output material identifier may be associated with the physical entity of the output material. The output material identifier may refer to a single batch of output material. The output material identifier may be associated with a group of output materials. The identifier may refer to multiple physical entities of the output material. The output material identifier may be associated with continuous or semi-continuous steam of output material. The identifier may refer to a stream of the output material e.g. over a certain time period or from a certain supplier.

The chemical production network may include multiple types of production processes for producing one or more output material(s) from one or more input material(s). The chemical production network may derive one or more output material(s) from the input material. The chemical production network may include a complex production network producing multiple output materials in multiple production chains. The chemical production network may include connected, interconnected and/or non-connected production chains. The chemical production network may include identity preserving or segregated production chains. Identity preserving or segregated in this context may refer to the environmental attributes of the input materials being preserved or segregated in the production chains. Examples are renewable or recycled input materials used to produce the one or more output material(s) without fossil content. Further examples are fossil input materials used to produce the one or more output material(s) with fossil content. Chemical production networks may include non-identity preserving or non-segregated production chains. Non-identity preserving or non-segregated in this context may refer to the input materials associated with the environmental attributes being mixed with input materials not associated with the environmental attributes. For example, non-identity preserving or non-segregated in this context may refer to the input materials associated with the environmental attributes being mixed with fossil input materials. Examples are fossil and renewable input materials mixed to produce the output material with fossil and renewable content.

The chemical production network may include one or more production chains with multiple production steps. The production steps included in the chemical network may be defined by the physical system boundary of the chemical production network. The system boundary may be defined by location or control over production processes. The system boundary may be defined by the site of the chemical production network. The system boundary may be defined by production processes controlled by one entity or multiple entities jointly. The system boundary may be defined by the value chain with staggered production processes to an end product, which may be controlled by multiple entities jointly or separately. The chemical production network may include a waste collection and sorting step, a recycling step such as pyrolysis, a cracking step such as steam cracking, a separation step to separate intermediates of one process step and further processing steps to convert such intermediates to output materials leaving the system boundary of the chemical production network. The entry points of the chemical production network may be marked by the entry of input materials to the chemical production network or the system boundary of the chemical network. The output materials may leave the physical system boundary of the chemical production network. The exit points of the chemical production network may be marked by the exit of output materials from the chemical production network or the system boundary of the chemical network.

Environmental attributes may refer to a property related to the environmental impact. Such property may be a property of the input or output materials. The environmental attribute may indicate an environmental performance of one or more material(s). The environmental attribute may be derived from properties of the input materials, the chemical production network and/or the output materials. The environmental attribute may be associated with the environmental impact of one or more material(s) at any stage during the lifecycle. The stages of the material or product lifecycle may include the stages of providing raw material, producing products, such as intermediate products or end products, using products, treating end-of-life products, recycling end-of-life products, disposing end-of-life products, reusing components from end-of-life products or any subset of stages. The environmental attribute may be specified or may be derived from any activity of one or more entities participating at any stage of the lifecycle of one or more material(s) or product(s).

The environmental attribute may include one or more characteristic(s) that are attributable to environmental impact of the material or product. The environmental attribute may include environmental, technical, recyclability or circularity characteristics(s) associated with the environmental impact of one or more material(s) or product(s).

Environmental characteristic(s) may specify or quantify ecological criteria associated with the products environmental impact. Environmental characteristic(s) may be or may be derived from measurements taken during the lifecycle of one or more product(s). Environmental characteristics may be determined at any stage of the product lifecycle and may characterize the environmental impact of the product for such stage or up to such stage. Environmental characteristic(s) may for example include carbon footprint, greenhouse gas emissions, resource usage, air emissions, ozone depletion potential, water pollution, noise pollution or eutrophication potential. Environmental characteristic(s) may for example include product characteristics related to the production of the product like bio based, vegan, halal, kosher, palm oil-free, natural or the like.

Technical characteristic(s) may specify or quantify product performance at least indirectly associated with the environmental impact. Technical characteristic(s) may be or may be derived from measurements taken during the lifecycle of one or more product(s). Technical characteristics may be determined at any stage of the product lifecycle and may characterize the product performance for such stage or up to such stage. Technical characteristic(s) may for example include product composition data, bill of materials, product specification data, product component data, product safety data, application property data, application instructions or product quality data.

Circularity characteristic(s) may specify or quantify the products life cycle characteristics associated with circular uses. Circularity characteristic(s) may be or may be derived from measurements taken during the lifecycle of one or more product(s). Circularity characteristic(s) may be or may be derived from circular data recorded in one or more prior lifecycle(s) including reuse. Circularity characteristics may be determined at any stage of the product lifecycle and may characterize the reuse or recycling performance for such stage or up to such stage. Circularity characteristic(s) may for example include recycling data, reuse rate, recycling rate, recycling loops, reuse reused product performance, reused product quality or the like.

Recyclability characteristic(s) may specify or quantify the material or product life cycle characteristics associated with recycling uses. Recyclability characteristic(s) may include the composition of the material including specifically tailored constituents making the material suitable for recycling. Recyclability characteristic(s) may be or may be derived from measurements taken during the lifecycle of one or more materials or product(s). Recyclability characteristic(s) may be or may be derived from recycling data recorded in one or more prior lifecycle(s). Recyclability characteristics may be determined at any stage of the material or product lifecycle and may characterize the recycling performance for such stage or up to such stage. Recyclability characteristic(s) may for example include recycling data, recyclability data, or the like.

The input material account may refer to a digital storage structure that stores data related to environmental attributes. The input material account may include a balance of environmental attributes. The account may be associated with meta data identifying the account for balancing environmental attributes. The account may be associated with meta data identifying the environmental attributes and the number of environmental attributes allocated to the account.

The account may be associated with meta data identifying the production chain the account is associated with. The account may be associated with meta data identifying the input or output material the account is associated with. The account may be part of a balancing system including multiple accounts. The account may hold environmental attributes for transaction. Environmental attributes may be allocated, added, deleted, withdrawn or deducted from the account.

In one embodiment upon allocating the environmental attribute to the input material account the environmental attribute is decoupled from the physical flow of input material(s) for production of the output material by the chemical production network. The steps of providing the input material to the chemical production network and providing the least one input material identifier, the least one environmental attribute and the quantity of input material may coincide or not coincide in timing. The input material may be physically provided to the chemical production network and on such providing of the physical input material the least one input material identifier, the least one environmental attribute and the quantity of input material may be provided. The input material may be physically provided to the chemical production network and prior or after such providing of the physical input material the least one input material identifier, the least one environmental attribute and the quantity of input material may be provided. The input material may be physically provided to the chemical production network and on such providing of the physical input material the least one input material identifier, and the quantity of input material may be provided. The least one environmental attribute corresponding to such input material may be provided prior or after providing of the physical input material.

Providing the least one input material identifier, the least one environmental attribute and the quantity of input material may relate to a specified physical entity of input material, such as a batch of input material provided to the chemical production network. For example, packaged input material may be provided in defined physical quantities. The at least one input material identifier, the least one environmental attribute and the quantity of input material may be associated with the defined quantity. Providing the least one input material identifier. the least one environmental attribute and the quantity of input material may relate to a non-specified physical entity of input material, such as such as a type of input material provided to the chemical production network in a continuous or semi-continuous stream. For example, input material may be provided as a continuous stream via a pipeline. The at least one input material identifier, the least one environmental attribute and the quantity of input material may be associated with the quantity of input material provided to the chemical production network in a timeframe, such as a specified or predefined time frame.

Providing input material to the chemical production network and allocating the environmental attribute to an input material account includes the separation of the input material further processed by the chemical production network and the environmental attribute associated with the input material on providing the input material to the chemical network. The physical input material may be process by chemical production network. The environmental attribute may be decoupled from the material flow of the input material through the chemical production network. The environmental attribute may be provided to the input material account and with such providing decoupled from the material flow of the input material through the chemical production network. The environmental attribute may be balanced via the input material account and such balancing may be decoupled from the material flow of the input material through the chemical production network. The input material account balance may depend on the physical input material entering the chemical production network and the associated environmental attribute. After allocation of the environmental attribute to the input material account the environmental attribute may be decoupled from the material flow of the input material through the chemical production network. For allocation of environmental attribute(s) to the output material produced by the chemical production network a segregated or non-segregated balancing scheme may be applied. For example, mass balance or book and claim schemes may be applied.

In one embodiment the environmental attribute relates to an environmental performance of the input material. The environmental performance of the input material may be derived from a property of the input material. Such property may relate to the composition, the manufacturing process producing the input material and/or the origin of the input material. The environmental attribute may for example specify the recycled or renewable content. The environmental attribute may for example specify the carbon footprint from producing the input material. The environmental attribute may for example specify the composition of the input material as palm oil free, vegan, halal, kosher. The environmental attribute may for example specify the composition of the input material as plam oil free, vegan, halal, kosher, natural.

In another embodiment the input material identifier is associated with the physical entity of the input material entering the chemical production network. The identifier may relate to one specific physical entity of the input product such as a product batch or a packaged product. The identifier may relate to a group of physical entities of the input material such as product batches or packaged products of an input material produced from one production chain or site.

In another embodiment the material identifier relates to a LOT number assigned to a certain physical entity, quantity or group of input material(s). The LOT number may be assigned to the input material on production. In addition or alternatively, the material identifier relates to an order number assigned to the transfer of a certain physical entity, quantity or group of input material(s) for the chemical production network. The order number may be assigned to the input material transfer. The order number may relate to the input material producer identity and the input material consumer entity.

In another embodiment the at least one input material identifier, the at least one environmental attribute associated with the respective input material identifier and the quantity of input material are provided on entry of the input material to the chemical production network. The input material may be physically provided to the chemical production network. Upon entry of the input material to the chemical production network the at least one input material identifier, the at least one environmental attribute associated with the respective input material identifier and the quantity of input material may be provided to a computing interface. The at least one environmental attribute associated with the respective input material identifier and the quantity of input material may be related to the at least one input material identifier. The input material identifier may be associated with the physical entity of the input material provided to the chemical production network. This way the virtual identifier of a material may be uniquely linked to the physical material. Such linking may include a physical or virtual link of identifiers uniquely associated with the physical material. For physical linking a tag or code may be physically connected to the material, e.g. by printing a QR code on the packaging. For virtual linking different identifiers associated with the physical material may be linked. For example, an order number, a batch number, LOT number or a combination thereof may be linked.

In another embodiment providing the quantity of input material includes providing a measured quantity, e.g. volume or amount, of input material fed into a material storage or fed into a plant of the chemical production network. The measured quantity may be provided by a sensor associated with the material storage, the plant or a providing system associated with the material storage or the plant. The providing system may be a pipeline continuously providing input material or a filling system intermittently providing input material. The measured quantity may include a mass, a mass per time frame or a mass per providing.

In another embodiment the input material identifier is associated with a certificate certifying the environmental attribute. The certificate may include the certificate type, the allocation scheme, the environmental attribute, the quantity of input material associated with the environmental attribute, the quantity of input material, the producer identifier, input material identifier or combinations thereof. The certificate may be a digital certificate. The certificate may include certificate data such as the certificate type, the allocation scheme, the environmental attribute, the quantity of input material associated with the environmental attribute, the quantity of input material, the producer identifier, input material identifier or combinations thereof.

In another embodiment the at least one environmental attribute and the quantity of input material provided to the chemical production network are associated with the input material identifier and authentication information. The authentication information may include at least one authentication mechanism based on a private-public-key infrastructure, a digital certificate issued by a certificate issuer, a biometric authentication service or combinations thereof. The authentication information may include a public key, wherein the public key associated with the input material identifier may be recorded in connection with the input material identifier in at least one authentication data registry.

In another embodiment the providing of the input material to the chemical production network triggers generation of a transaction record assigning the input material identifier from an input material producer identifier to an input material user identifier. The transaction record may comprise input material identifier, the input material producer identifier and the input material consumer identifier. The transaction record may further comprise a time stamp and data related to the input material identifier such as the certificate type, the allocation scheme, the environmental attribute, the quantity of input material associated with the environmental attribute, the quantity of input material, the producer identifier, input material identifier or combinations thereof.

In another embodiment the one or more environmental attributes from at least one input material account associated with the respective environmental attribute may be associated with the output material identifier. One or more environmental attribute(s) may by assigned to the output material identifier and with that to the output material. The assignment may be executed based on allocation rules relating input material, input material account and output material. The allocation rules may include instructions that allocate one or more environmental attribute(s) from the input material to the input material account associated with the respective environmental attributes. The allocation rules may include instructions that assign one or more environmental attribute(s) from the input material account(s) to the output material to be associated with the respective environmental attribute(s).

In another embodiment the one or more environmental attribute(s) are converted based on the quantity of input material provided into environmental unit(s). The environmental unit(s) may relate to a methane equivalent, an energy property such as heating value, a number of carbon atoms or any other suitable measure for the environmental impact of the environmental attribute. By converting the environmental attribute(s) depending on the quantity of input material environmental unit(s) may act as an environmental currency. The environmental unit(s) may be allocated to the respective input material account for the environmental attribute. This may include adding the environmental unit(s) to the environmental account. Linking the one or more environmental attribute(s) from at least one input material account associated with the respective environmental attribute to the output material identifier may include deducting the one or more environmental unit(s) from the input material account and assigning the one or more environmental unit(s) to the output material identifier. This way double spending can be avoided.

In another embodiment the environmental unit(s) linked to the output material identifier are determined based on a number of environmental unit(s) linked to the one or more input material(s) used for producing the output material. The link to the one or more input material(s) used for producing the output material may depend on the production chain. If the production chain is a connected production chain, where output material(s) are derived from more than one set of input material(s), the link may relate to a non-segregated production chain using a mass balance or a book and claim allocation scheme. If the production chain is a non-connected production chain, where output material(s) are derived from one set of input material(s), the link may relate to a segregated production chain using a segregated allocation scheme.

In another embodiment the output material associated with the output material identifier is provided physically and the at least one output environmental attribute associated with the output material identifier is provided virtually. Through the association of the physical output material and the environmental attribute with the output identifier the physical entity of the output material is connected to the virtual entity of the environmental attribute.

In one embodiment producing the output material at least in part from the one or more input material(s) includes producing the output material from input material(s) that were fed into the chemical production network. The input material(s) required to produce the output material may be provided by chemical production data specifying input material(s), intermediate(s), production processes and/or output material(s). The chemical production data may specify the production chain(s) of the chemical production network. The chemical production data may include a bill of materials for one or more production chain(s) of the chemical production network. The chemical production data may include one or more recipe(s) specifying one or more input material(s) for production process(es) of the chemical production network.

In one embodiment the linking of one or more environmental attribute(s) to the output identifier may include the selection of environmental attribute(s) based on the input material(s) used to produce the output material. The input material(s) may be determined from chemical production data. The environmental attribute(s) from associated input material account(s) may be linked to the output material identifier. The environmental attribute(s) linked to the output identifier may be decoupled from the physical flow of input material(s) during production by the chemical production network. The environmental attribute linked to the output identifier may be decoupled from the physical flow of input material(s) for production of the output material by the chemical production network. The environmental attribute(s) may be balanced independent from the physical flow of input material(s) during production by the chemical production network. The environmental attribute(s) may be balanced based on the system boundary of the chemical production network. The environmental attribute(s) may be balanced based on the input material(s) entering the system boundary of the chemical production network and the out material(s) exiting the chemical production network.

In another embodiment the at least one output environmental attribute associated with the output material identifier are provided as decentral asset including a decentral identifier, cryptographic information and the at least one environmental attribute. The decentral asset may be provided to a decentral network. The decentral asset may be provided for access by an asset transaction service or a data consuming service associated with the output material consumer. This allows transfer of or access to the at least one environmental attribute in a controlled and secure manner.

### BRIEF DESCRIPTION OF THE DRAWINGS

FIG. 1 illustrates an example of a chemical production network producing one or more output material(s) from one or more input material(s) in connection with an operating system including an attribute management system.

FIGS. 2a-c illustrate a part of a chemical production network producing multiple output material(s) from fossil and non-fossil input material(s).

FIGS. 3a-c illustrate examples of allocation schemes allocating the use of renewable or bio-based input materials to output materials of the chemical production network.

FIG. 4 illustrates an example of a chemical production network with different allocation schemes.

FIG. 5a, b illustrate inbound and outbound allocation of environmental attributes for a chemical production network.

FIG. 6 illustrate an example of a method for registering at least one input material associated with at least one environmental attribute.

FIG. 7 illustrate an example of a method for linking one or more environmental attribute(s) from the at least one input material account associated with the respective environmental attribute to the output material identifier.

FIG. 8 illustrate an example of a method for producing at least one output material associated with at least one environmental attribute in a supply chain.

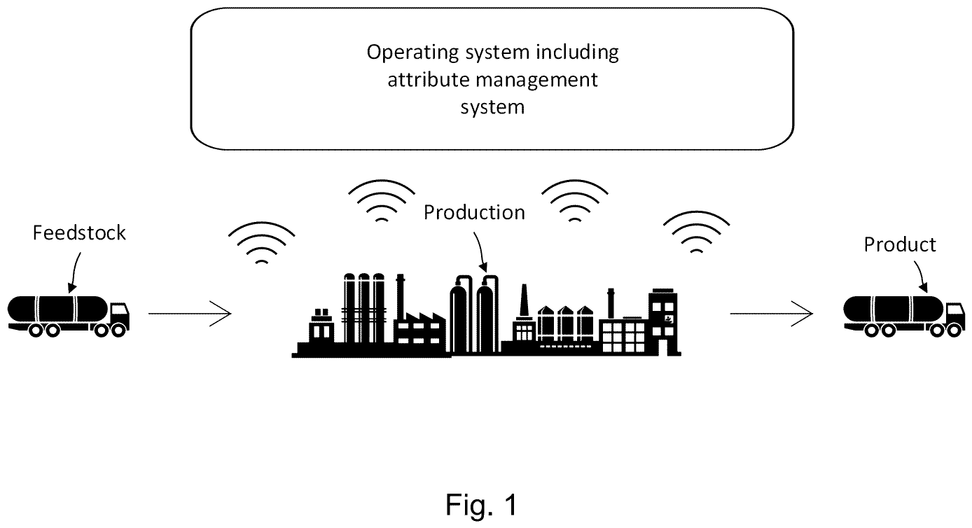

FIG. 1 illustrates an example of a chemical production network producing one or more output material(s) from one or more input material(s) in connection with an operating system including an attribute management system.

For producing one or more output product(s) different input materials may be provided as physical inputs from material providers or suppliers. The input or output materials may have one or more properties related to environmental impact of the input or output products.

The chemical production network may include multiple interlinked processing steps. The chemical production network may be an integrated chemical production network with interrelated production chains. The chemical production network may include multiple different production chains that have at least one intermediate product in common. The chemical production network may include multiple stages of the chemical value chain. The chemical production network may include the producing, refining, processing and/or purification of gas or crude oil. The chemical production network may include a stream cracker, or a syngas plant connected to multiple production chains that derive chemical products from the effluent of such plants. The chemical production network may include multiple production chains that derive from one or more input material(s) as input chemical products as output. The chemical production network may include multiple tiers of a chemical value chain. The chemical production network may include a physically interconnected arrangement of production sites. The production sites may be at the same location or at different locations. In the latter case the production sites may be interconnected by means of dedicated transportation systems such as pipelines, supply chain vehicles, like trucks, supply chain ships or other cargo transportation means.

The chemical production network may chemically convert input materials to one or more output materials. The chemical production network may convert input materials by way of chemical conversion to one or more output materials. The input materials may be considered input materials for the chemical production network.

The input materials may be fed into the chemical production network at any entry point. The input materials may be fed into the chemical production network at the start of the chemical production network. Input materials may for example make up the feedstock of a steam cracker. The input material may include a bio-based, a recycled and/or a fossil input material for the manufacture of chemical intermediates and chemical products.

The chemical production network may include multiple production steps. The production steps included in the chemical network may be defined by the system boundary of the chemical production network. The system boundary may be defined by location or control over production processes. The system boundary may be defined by the site of the chemical production network. The system boundary may be defined by production processes controlled by one entity or multiple entities jointly. The system boundary may be defined by value chain with staggered production processes to an end product, which may be controlled by multiple entities separately. The chemical production network may include a waste collection and sorting step, a recycling step such as pyrolysis, a cracking step such as steam cracking, a separation step to separate outputs of one process step and further processing steps to convert such outputs to a chemical product leaving the system boundary of the chemical production network.

The operating system of the chemical production network may monitor and/or control the chemical production network based on operating parameters of the different processes. One process step monitored and/or controlled may be the feed of input materials or the release of output materials. Another process step monitored and/or controlled may the allocation of environmental attributes to chemical products produced via the chemical production network. Yet another process step monitored and/or controlled may be the registration of environmental attributes associated with input materials entering the system boundary of the chemical production network. Yet another process step monitored and/or controlled may be the management of environmental attributes associated with input materials and chemical products of the chemical production network.

The operating system may be configured to access data related the inputs materials, the processes and/or the output materials. The operating system may be configured to convert a recycled or bio-based content of the one or more input material(s) used in the chemical production network to balancing units. The operating system may be configured to allocate the balancing units to at least one balancing account associated with the recycled or bio-based content of the input materials. The operating system may be configured to allocate at least a part of the balancing units from the at least one balancing account to the at least one chemical product.

The operating system may be configured to handle balancing units related to the input and output materials of the chemical production network. In particular, the operating system may be configured to determine balancing units associated with the use of input materials impacting the environmental property of the chemical production network and the output materials produced by the chemical production network. Further in particular, the operating system may be configured to determine balancing units associated with the output materials and the environmental property of the output materials. This way the operating system may be configured to store balancing units in balancing accounts or to delete balancing units from the balancing accounts. The balancing units may be viewed as a credit that may be deposited in an account or deducted from an account related to the input and output materials of the chemical production network.

The operating system may be configured to register inbound environmental attributes, to assign outbound environmental attributes and to manage inbound registration as well as outbound assignment via allocation rules.

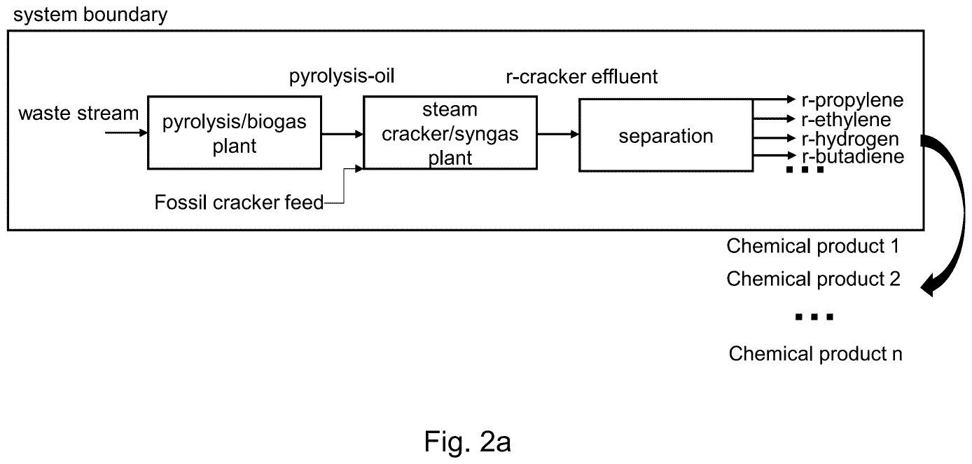

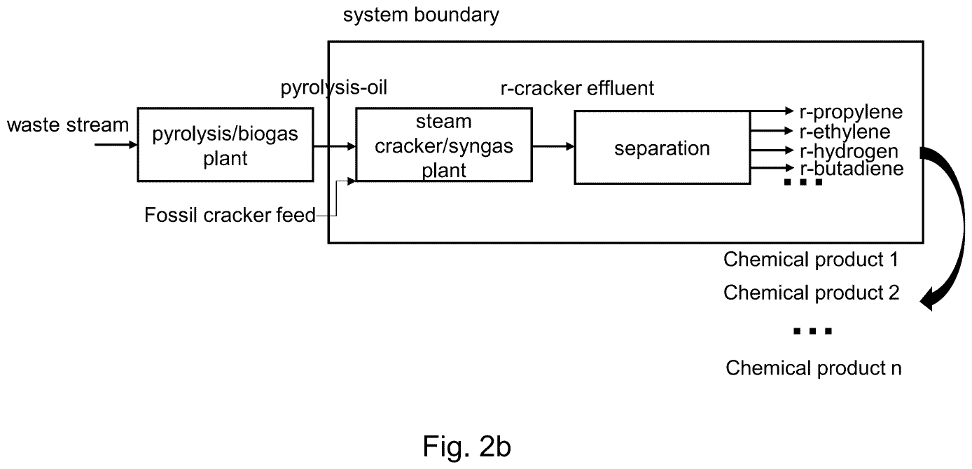

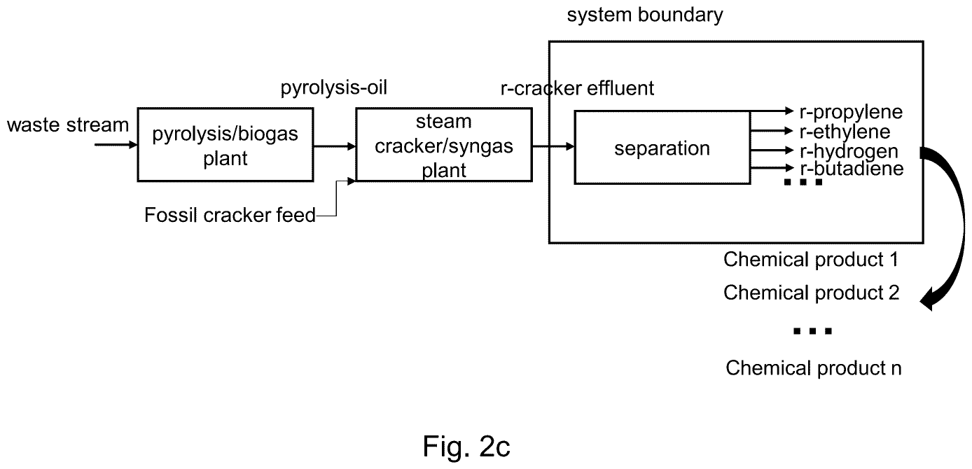

FIGS. 2a-c illustrate a part of a chemical production network producing multiple output material(s) from fossil and non-fossil input material(s).

The chemical production network may comprise a pyrolysis unit for pyrolysis of recycled waste. A recycled waste stream may feed the pyrolysis unit. Recycled waste stream may include plastics, rubber (including tires), textiles, wood, biowaste, modified celluloses, wet laid products, and any other material suitable for pyrolysis. The recycled waste stream may include a stream containing at least in part post-industrial, or post-consumer, or both post-industrial and post-consumer materials. A post-consumer material is one that has been used at least once for its intended application for any duration of time regardless of wear, or has been sold to an end use customer, or which is discarded into a recycle bin by any person or entity other than a manufacturer or business engaged in the manufacture or sale of the material. A post-industrial material is one that has been created and has not been used for its intended application, or has not been sold to the end use customer, or discarded by a manufacturer or any other entity engaged in the sale of the material. Examples of post-industrial materials include rework, regrind, scrap, trim, out of specification materials, and finished materials transferred from a manufacturer to any downstream customer (e.g. manufacturer to wholesaler to distributor) but not yet used or sold to the end use customer. The waste stream may be isolated as one type of waste stream with specific waste material or it may be a stream of mixed wastes.

Examples of plastics as a waste stream include high density polyethylene and copolymers thereof, low density polyethylene and copolymers thereof, polypropylene and copolymers thereof, other polyolefins, polystyrene, polyvinyl chloride (PVC), polyvinylidene chloride (PVDC), polyesters including polyethylene terephthalate, copolyesters and terephthalate copolyesters (e.g. containing residues of TMCD, CHDM, propylene glycol, or NPG monomers), polyethylene terephthalate, polyamides, poly(methyl methacrylate), polytetrafluoroethylene, acrylobutadienestyrene (ABS), polyurethanes, cellulosics and derivates thereof such as cellulose acetate, cellulose diacetate, cellulose triacetate, cellulose propionate, cellulose butyrate; regenerated cellulosics such as viscose and rayons, epoxy, polyamides, phenolic resins, polyacetal, polycarbonates, polyphenylene-based alloys, polypropylene and copolymers thereof, polystyrene, styrenic compounds, vinyl based compounds, styrene acrylonitrile, thermoplastic elastomers, and urea based polymers and melamine containing polymers.

The waste stream may be fed to a pyrolysis unit. The pyrolysis effluent exiting the pyrolysis unit may comprise pyrolysis gas, pyrolysis vapors, and residual solids. The pyrolysis oil may be used as feedstock for a cracker. The pyrolysis oil may be fed to the cracker as recycled feedstock together with a non-recycle or conventional feedstock (e.g., propane, ethane, and/or natural gasoline). In addition to the recycled feedstock bio-based feedstock may be fed to the cracker. In further embodiments pyrolysis wax, pyrolysis gas, pyrolysis char, or synthesis gas may be provided to as feedstock. In yet further embodiments bio-naphtha may be produced through hydrogenation of bio-based material such palm oil and tallow and provided as feedstock to the cracker.

A recycled and/or bio-based content cracked effluent may be produced from the cracker and then subjected to separation in a separation train. In an embodiment or in combination with any embodiment mentioned herein, the recycled or bio-based content composition can be separated and different product streams containing recycled or bio-based content may be recovered from the recycled or bio-based content cracked effluent. For instance, a propylene stream containing recycled or bio-based content may contain predominantly propylene, or an ethylene stream containing recycled or bio-based content may contain predominately ethylene. The product stream containing recycled or bio-based content may be further processed to output products or end products.

In one embodiment or in combination with any of the mentioned embodiments, the “r-ethylene” can be a composition comprising: (a) ethylene obtained from cracking of a cracker feed containing r-pyoil, or (b) ethylene having a recycle content value attributed to at least a portion of the ethylene; and the “r-propylene” can be a composition comprising (a) propylene obtained from cracking of a cracker feed containing r-pyoil, or (b) propylene having a recycle content value attributed to at least a portion of the propylene.

In one embodiment or in combination with any of the mentioned embodiments, there is now provided a method for processing recycle content olefin including, for example, recycle content propylene, by feeding the r-olefin to a reactor in which is made r-aldehydes, which are subsequently hydrogenated to form oxo alcohols. In some embodiments, the r-aldehydes may include r-butyraldehyde, which can be further condensed in an Aldol condensation reactor to form an a,f3-aldehyde such as 2-ethylhexenal and/or 2-ethylhexanal. These a,f3-aldehyde can then be hydrogenated to form various oxo alcohols, including, for example 2-ethylhexanol, which itself can be used to form a variety of other compounds, including oxo plasticizers.

FIG. 2a illustrates an embodiment for a system boundary of the chemical production network, which includes the pyrolysis step. The waste stream forms the entry point into the chemical production network. The chemical end products form the exit point out of the chemical production network. FIG. 2b illustrates another embodiment for the system boundary of the chemical production network, which excludes the pyrolysis step. The pyrolysis oil and the fossil feed form the entry point into the chemical production network. The chemical end products form the exit point out of the chemical production network. FIG. 2c illustrates another embodiment for the system boundary of the chemical production network, which excludes the pyrolysis step and the cracking step. The cracker effluent derived at least in part from pyrolysis oil forms the entry point into the chemical production network. The chemical end products form the exit point out of the chemical production network. The chemical production networks and the system boundaries illustrated in FIGS. 2a to 2c are examples and should not be considered limiting.

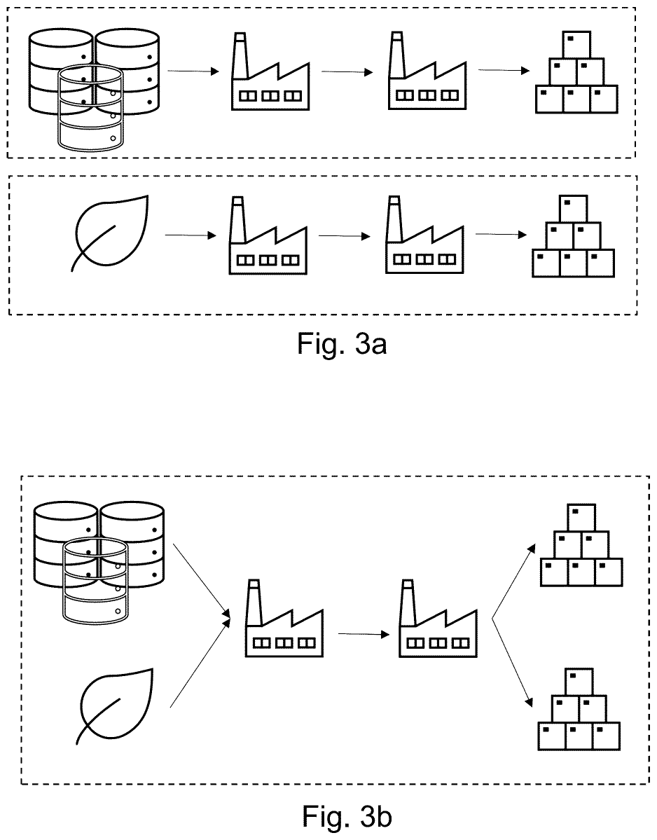

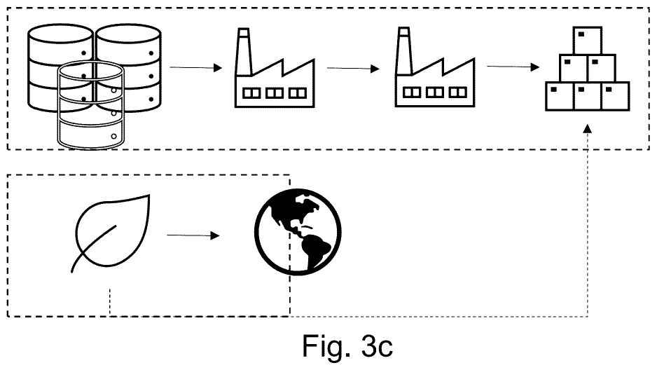

FIG. 3a to c illustrate examples of allocation schemes allocating the use of renewable or bio-based input materials to output materials of the chemical production network.

As illustrated in FIGS. 1 and 2 chemical production networks can comprise complex interconnected production sites that chemically convert one or more input materials via chemical processing to one or more output materials. To account for the use of recycled or renewable content in chemical production, allocation rules may be used. This way recycled, renewable or bio-based content of input materials may be allocated to output materials. The renewable content may be based on input material from renewable sources. The renewable content may comprise bio-based input materials derived from living organisms such as different types of crops, wood or algae. The recycled content may comprise any recycled material used in production of new materials. This may include any recycled bio-based or bio-based materials e.g. as derived from chemical or mechanical recycling.

Accounting principles for allocating the use of recycled or renewable content are for example defined in ISO 22095. Four different models may be used: Identity preservation models, segregated models, mass balance models, or book and claim models.

FIG. 3a illustrates an example of a dedicated or segregated production network. The production network comprises a first production chain for producing the output material from fossil material and a second production chain for producing the output material from bio-based input materials. The first and the second production chain are not interconnected. The first and the second production chain produce a fossil-based and a bio-based output material, respectively. Example for such dedicated production environments include fermentation or chemical transformation, such as polyethylene production from sugar cane, bio-poly lactic acid (PLA) production from corn, bio-succinic acid, or bio-butanediol (BOO).

FIG. 3b illustrates an example of a complex production network. In contrast to the production network of FIG. 3a the fossil-based input materials are co-fed and mixed with bio-based input materials. The production network produces via one or more chemical process chains with intermediates one or more material outputs or products. For the sake of simplicity FIG. 3b illustrates the mass balancing approach for one chemical process chain producing one output material or product. In the mass balancing model, the physical mixing or co-feeding of bio-based input material with conventional fossil input materials is accounted for. Here the feed into the production network and the feed of output products form a system boundary. The mass balance of input and output materials connect the used bio-based input material to the produced output product. Mass balance allows to keep track of the total quantity, e.g. amount, of input material (e. g. recycled or bio-based or bio-based materials) throughout the production network and allows for allocation to output materials. Materials with different sets of specified characteristics may be mixed. E. g. recycled or bio-based feedstock replaces an equivalent quantity, e.g. amount, of fossil feedstock at the beginning of the value chain (input material) and is allocated to a product (output material) in such a manner that the input and output match. For this model, the proportion of the input with specified characteristics might only match the initial proportions on average and will typically vary across different outputs. This means that e.g. renewable and fossil input materials are mixed and that the chemical or technical proportions in each output material are not tracked.

Mass balance may include conversion factors to ensure the quantity, e.g. amount, of input material is correlated with the quantity, e.g. amount, of output material. The calculation may be made over a pre-defined or specified time period. Mass balance may be based on a balancing unit such as mass, energy or carbon.

Like FIG. 3b, FIG. 3c illustrates a complex production network associated with a book and claim scheme. In book and claim scheme, the characteristic renewable or recycled input material is not linked to the actual material flows. Book & Claim allows to de-couple specific characteristic, such as renewable, from the physical product and to transfer the characteristic separately via a dedicated registry in the form of a digital asset. This approach may be used for renewable energy. Book and claim may be based on a book and claim accounting unit such as watts or kilowatts for electricity.

In identify preservation models or segregated approaches as illustrated in FIG. 3a renewable, recycled or bio-based input materials may not be mixed with fossil input material. In mass balance or book and claim approaches as illustrated in FIGS. 3b and 3c renewable or recycled or bio-based materials with fossil input material may be mixed. In view of the increasing number of different sources for more sustainable chemical production and the number of allocation schemes, an efficient and robust operation system for operating complex production networks like chemical production networks is required.

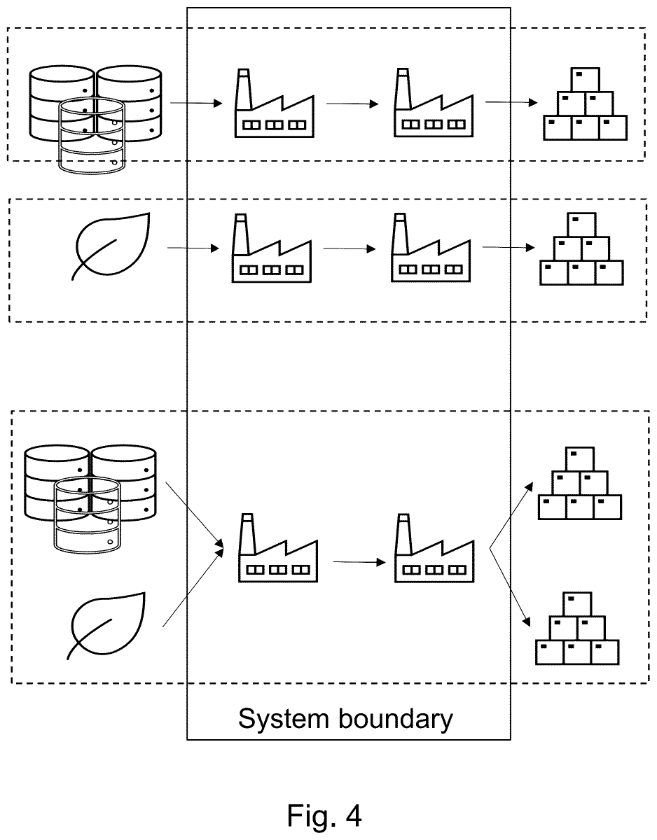

FIG. 4 illustrates an example of a chemical production network including metadata structure.

The chemical production network may include multiple production chains with different allocation schemes. The production chains may be signified by the material output(s) produced via such production chains. The production chain logic may include process data associated with process steps from input material(s) to output material(s). For each production chain an allocation scheme may be applicable or assign to. In addition for each production chain a balancing system may be applicable or the production chain logic may be embedded in the allocation rules.

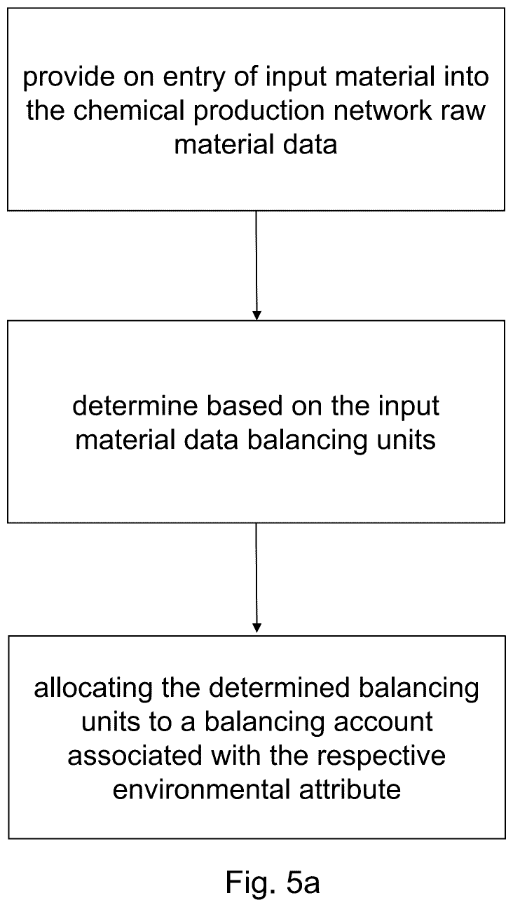

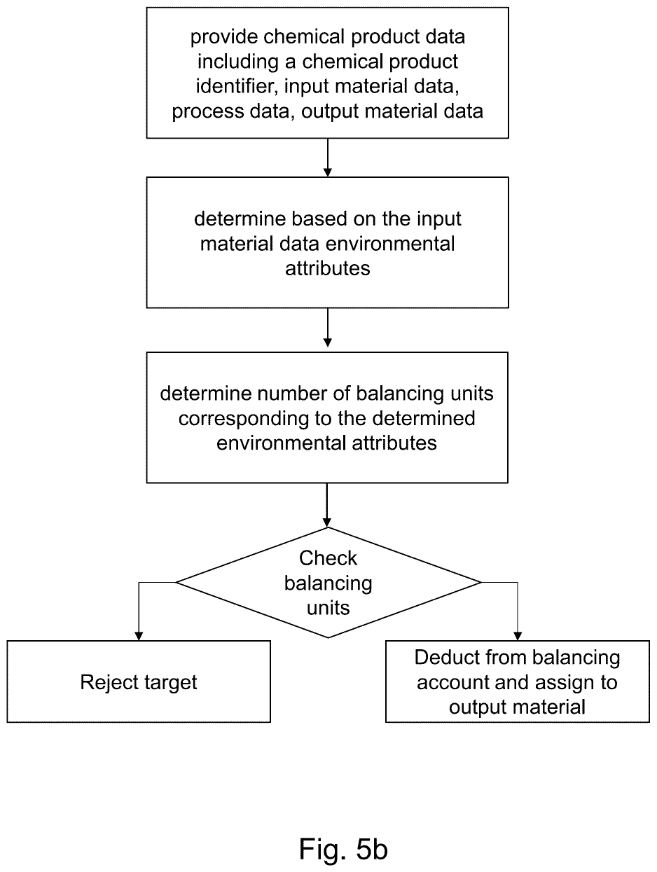

FIG. 5a, b illustrate inbound and outbound allocation of environmental attributes for a chemical production network.

FIG. 5a illustrates an example of an inbound allocation process for the chemical production network.

As for example illustrated in FIG. 1 the chemical production network may be operated by the operating system configured to register inbound environmental attributes, to assign outbound environmental attributes and/or to manage inbound registration as well as outbound assignment via allocation rules. The allocation rules may include allocation schemes as illustrated in FIGS. 3a-c. The chemical production network may include the network as illustrated in FIG. 2.

On input material(s) entering the chemical production network or the physical system boundary of the chemical production network the inbound allocation takes place. In this context input material signifies any material that enters the system boundary of the chemical production network and is used to produce output materials leaving the chemical production network. Such input material(s) may be associated with an input material identifier. Possible identifiers include decentral identifiers, input material specification, input material order number, input material LOT number, input material batch number, input material supplier specification or combination thereof.

On entry of the input material into the chemical production network input material data may be registered. The input material data may include input material identifier, input material quantity, e.g. amount, and/or one or more environmental attribute(s) associated with the input material.

Based on the input material data, in particular the input material quantity and/or one or more environmental attribute(s) associated with the input material, balancing units may be determined by converting the input material quantity to balancing units for the respective environmental attribute. The balancing units may relate to carbon atoms, methane equivalents, or any other suitable measure for the environmental impact of the environmental attribute. For example, the conversion to balancing units may include the conversion of the input material quantity to an energy property including material losses that occur during production of output product(s).

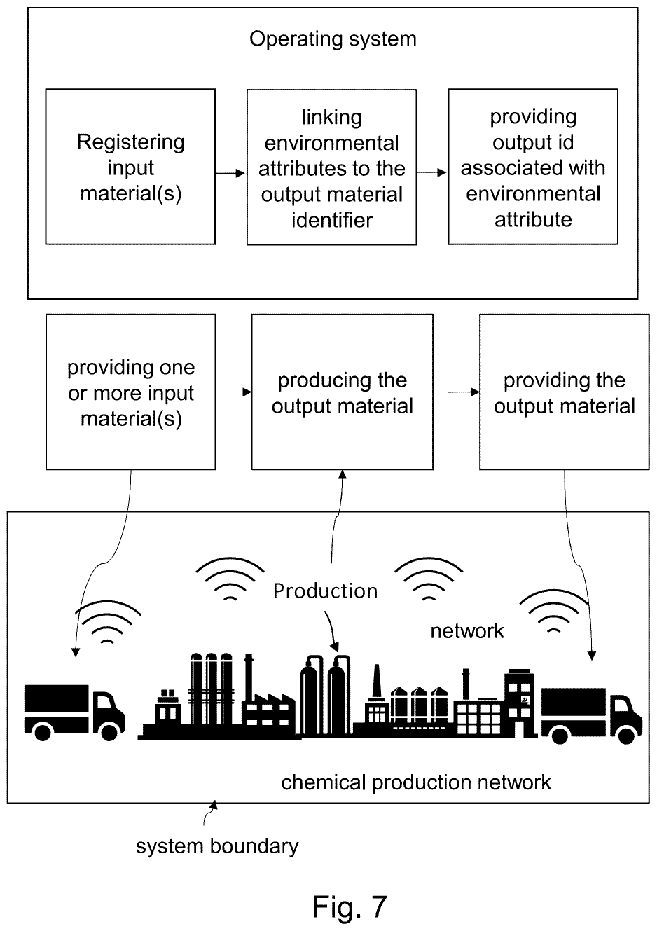

The balancing units may be allocated to a balancing account associated with the respective environmental attribute. This way the environmental attributes associated with input material(s) entering the chemical production network can be tracked or stored in an accounting system. An example of an accounting system is shown in FIGS. 7a-d, where each balancing account is associated with metadata signifying the input material such as pyrolysis oil, environmental attribute type such as recycled material and material origin such as recycled from tires. For allocation the input material data may include respective metadata for the input material.

Allocation rules may include instructions to allocate the environmental attribute(s) included in the input material data to the respective balancing account. In the inbound process such allocation rules may be used to allocate environmental attributes from the input material data to the balancing system.

For example the method for allocating balancing units may be associated with pyrolysis oil as input material to a complex chemical production network to the output products of the complex chemical production network.

In a first step the quantity and type of waste is provided to a computing interface. The quantity and type of waste are stored in connection with the pyrolysis plant(s) and pyrolysis oil produced by plant. For instance, a pyrolysis oil producer may operate multiple plants and may track the quantity and type of waste fed to the plants. The waste may be provided separately according to type of waste or the waste may be mixed. Based on such tracking the quantity of pyrolysis oil and type of waste may be allocated to the produced pyrolysis oil.

In a second step the quantity of pyrolysis oil and the type of waste may be provided to a second computing system associated with the operating system of a complex chemical production network. Based on the quantity of pyrolysis oil balancing units may be generated. Such generation may include a conversion factor that takes account of the chemical difference between fossil-based input materials such as naphtha and methane. In one example the conversion factor may relate to the lower heating value of the pyrolysis oil in relation the lower heating value of naphtha or methane. The conversion factor may for instance include the ratio of the lower heating value of pyrolysis oil and naphtha or methane. This way the chemical difference between the fossil and the recycled input material can be taken into account.

The balancing units may be allocated to the respective balancing account. For example the allocation rule may be associated with balancing account 1 of FIG. 5. In such a case the balancing units for the pyrolysis oil derived from waste of the waste type and used in a specified quantity in the production network will be allocated to balancing account 1. On production of the output products such balancing units may be allocated to the output material according to the allocation rule. An allocation rule that specifies free attribution between production processes of the chemical production network provides for reliable allocation in complex production networks.

FIG. 5b illustrates an example of an outbound allocation process for the chemical production network.

As for example illustrated in FIG. 1 the chemical production network may be operated by the operating system configured to register inbound environmental attributes, to assign outbound environmental attributes and/or to manage inbound registration as well as outbound assignment via allocation rules. The allocation rules may include allocation schemes as illustrated in FIGS. 3a-c. The chemical production network may include the network as illustrated in FIG. 2.

The output material may be produced from input material that entered the chemical production network. Output material data including an output material identifier may be provided. The output material data may further include input material data associated with the input materials used to produce the output material, process data associated with the production chain for producing the output materials and/or output material data associated with the output materials, such as an output material specification or an output material quantity.

Based on the input material data environmental attributes associated with the input material(s) used to produce the output material may be determined. The input material data may specify the total quantity of input material(s) that entered the production chain for producing the quantity of output material. The input material data may further specify the environmental attributes available for the respective input material(s). From the total quantity of input material(s), the number of balancing units for respective environmental attributes available for such input material(s) may be determined. This way the maximum number of balancing units for the respective environmental attribute attributable to the output material may be determined.

Based on the environmental attribute(s) attributable to the output material, the number of balancing units corresponding to the determined environmental attributes may be determined. The determined balancing units may be compared to balancing units stored in balancing account(s) for the respective environmental attribute(s).

If the balance of the respective balancing account(s) for the respective environmental attribute(s) is not sufficient, the environmental attribute(s) is rejected. If the balancing units are available, the balancing units are deducted from the respective balancing account(s) and the environmental attribute(s) are assigned to the output material and

An example of an accounting system is shown in FIGS. 7a-d, where each balancing account is associated with metadata signifying the input material such as pyrolysis oil, environmental attribute type such as recycled material and material origin such as recycled from tires. For assignment of the environmental attribute(s) to the output material, allocation rules may be defined. Allocation rules may include instructions to assign the environmental attribute(s) included in the input material data from the respective balancing account to the output material(s). In the outbound process such allocation rules may be used to assign environmental attributes from the balancing system to the output material(s).

FIG. 5a illustrates an example of the method for providing input material to a chemical production network.

Production demand data associated with the production planning for the chemical production network may be provided. The production demand data may be derived from target production capacities for one or more output material(s) produced by the chemical production network. The production demand data may be derived from pre-defined production capacities or data-driven models that relate production capacities to market demand data. The production demand data may include target capacities for chemical products produced by the chemical production network.

A bill of materials associated with output material may be provided. The bill of materials may include input material data associated with the input materials used to produce the output material, process data associated with the production chain for producing the output materials and/or output material data associated with the output materials, such as an output material specification or an output material quantity.

Based on the production demand data and the bill of materials input material demand data, in particular the quantity of input material required to produce the target capacities of chemical products, may be determined. An example of input material demand data is shown in FIG. 5c. The input material demand data may include input material identifiers associated with input materials required to produce the chemical products and input material quantitys for respective input materials. The input material demand data may include one or more input material specifier(s) per input material identifier signifying the input material specification. The input material demand data may include the input material quantity per input material identifier signifying the quantity of input material to be supplied. The input material demand data may include one or more environmental attribute(s) associated with respective input material. As an example, the input material demand data may include renewable content, bio-based content, recycled content or a combination thereof as environmental attribute. The environmental attribute may be provided from a data base specifying the environmental attribute(s) per input material. The environmental attribute may be selected from a data base specifying available environmental attribute(s) per input material. Such selection may be done based on availability data for the input material with the respective environmental attribute. The input material data may include the environmental attribute in combination with a certificate from an independent third party certifying the environmental attribute.

Input material demand data may be provided for access by a supplier system associated with a supplier outside physical system boundary of the chemical production network. Input material supply may be triggered by the supplier system accessing the input material demand data.

FIG. 5b illustrates an example of the system configured to trigger input material demand for a chemical production network based on input material demand data.

The production planner is configured to provide data associated with the production planning for the chemical production network as described in the context of FIG. 5a. The production planner may be configured to derive production demand data from target production capacities for one or more output product(s) produced by the chemical production network as described in the context of FIG. 5a.

The production process and product database may be configured to provide the bill of materials associated with chemical product data as described in the context of FIG. 5a. The production process and product database may be configured to provide the environmental attribute per input material.

The input material demand planner may be configured to determine input material demand data as described in the context of FIG. 5a. The input material demand planner may be configured to select the environmental attribute as described in the context of FIG. 5a.

The input material demand provider may be configured to provide input material demand data and to trigger material supply as described in the context of FIG. 5a. The network including supplier system may be configured to access input material demand data and to trigger material supply as described in the context of FIG. 5a. In particular the input material demand provider may be configured to provide input material demand data for access by a supplier system associated with a supplier outside physical system boundary of the chemical production network. Input material supply may be triggered by the supplier system accessing the input material demand data.

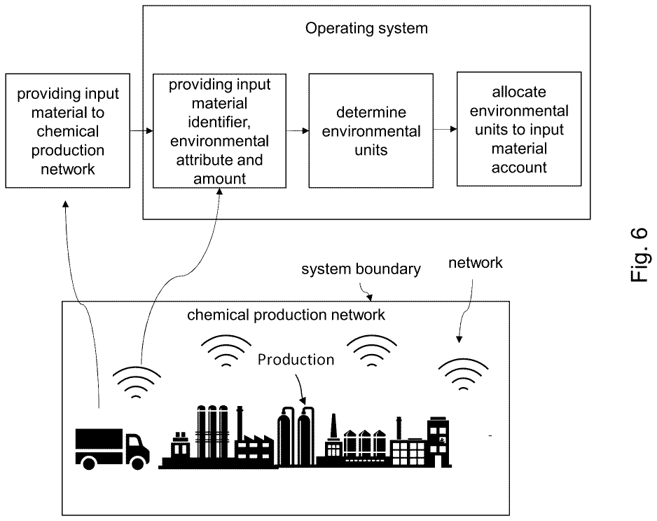

FIG. 6 illustrates an example of a method for registering at least one input material associated with at least one environmental attribute.

The input materials such as pyrolysis oil, bio-naphta or bio-gas may be provided to the chemical production network. The input materials may enter the system boundary of the chemical production network at the entry point, such as a stream cracker. The input materials may be used in the chemical production network to derive one or more output material(s) from the input materials. Output material(s) may be MDI, TDI, PC, Polyols, Caprolactam, adipic acid, HMD, Polyamides, . . .

On entry of the input material input material data may be provided via a network to the interface of the operating system. the input material identifier associated with the respective input material, the environmental attribute associated with the respective input material and the quantity of input material provided to the chemical production network may be provided. Such data may be provided via a network on entry of the system boundary, or the data may be transferred from a computing system to the operating system.

The input material identifier may be associated with the physical entity of the input material entering the chemical production network. A Tag may be placed on the delivery truck providing the input identifier and related data. The input material identifier may be a LOT number assigned to a certain quantity or group of input material(s) and/or the material identifier relates to an order number assigned to the transfer of a certain quantity or group of input material(s) for the chemical production network. The data related to the input material identifier may include the environmental attribute associated with the respective input material, the quantity of input material and the certificate certifying the environmental attribute. The quantity of input material may be a measured quantity, e.g. amount, volume or energy property, of input material fed to a plant or storage of the chemical production network for producing one or more output material(s) from the input material(s).

The input material identifier may be provided and the related data may be accessed via a network and retrieved from a input product producer system. The at least one environmental attribute and the quantity of input material provided to the chemical production network may be associated with the input material identifier and authentication information. The providing of the input material to the chemical production network triggers generation of a transaction record assigning the input material identifier from an input material producer identifier to an input material user identifier.

Based on the quantity of input material the environmental attribute may be allocated to an input material account associated with the respective environmental attribute. For such allocation environmental units may be determined. The quantity of input material such as pyrolysis oil may be converted to environmental units. This may include a conversion factor that takes account of the chemical difference between fossil-based input materials such as naphtha and methane and non-fossil-based input materials such as bio-naphtha or pyrolysis oil. In one example the conversion factor may relate to the lower heating value of the pyrolysis oil in relation the lower heating value of naphtha or methane. The conversion factor may for instance include the ratio of the lower heating value of pyrolysis oil and naphtha or methane. This way the chemical difference between the fossil and the recycled input material can be taken into account.

The environmental units may be allocated to the respective input material balancing account. For example, the allocation rule may be associated with balancing account for pyrolysis oil. On production of the output products such environmental units may be assigned to the output materials. An allocation rule that specifies free attribution between production processes of the chemical production network provides for reliable allocation in complex production networks.

FIG. 7 illustrates an example of a method for linking one or more environmental attribute(s) and for producing at least one output material associated with at least one environmental attribute.

On the physical layer, the input material may be provided to the chemical production network. The output material may be produced and provided to exit the chemical production network.

On the virtual layer, the input material associated with at least one environmental attribute may be registered to the input material account as described in the context of FIGS. 4 and 6. To identify the output material in the virtual system the output material identifier associated with the produced output material is generated and provided. Based on the registered environmental attributes and the output material identifier one or more environmental attributes from the at least one input material account associated with the respective environmental attribute is linked to the output material identifier. Linking one or more environmental attributes may include deducting the one or more environmental unit(s) from the input material account and assigning the one or more environmental unit(s) to the output material identifier. The environmental unit(s) linked to the output material identifier may be determined based on the number of environmental unit(s) linked to the one or more input material(s) used for producing the output material. This way the output material may not be assigned more environmental attributes than would be available to the output material based on the used input materials. The mass balance generated through such a scheme allows for flexibly assigning environmental attributes to output materials, while preserving the mass equivalent of input materials associated with environmental attributes.

Similar to the physical layer the environmental attributes associated to the output identifier are provided. Since the output identifier is associated with the physical output product and its virtual environmental attributes, the output material can be provided associated with the environmental attribute. The output material associated with the output material identifier may hence be provided physically and the at least one output environmental attribute associated with the output material identifier may be provided virtually.

To access the environmental attribute virtually in a controlled and secure manner, the environmental attribute associated with the output material identifier may be provided as decentral asset including a decentral identifier, cryptographic information and the at least one output environmental attribute. The decentral asset may be provided to a decentral network.

The decentral asset may be provided for access by an asset transaction service or a data consuming service associated with the output material consumer. This allows transfer of or access to the at least one environmental attribute in a controlled and secure manner.

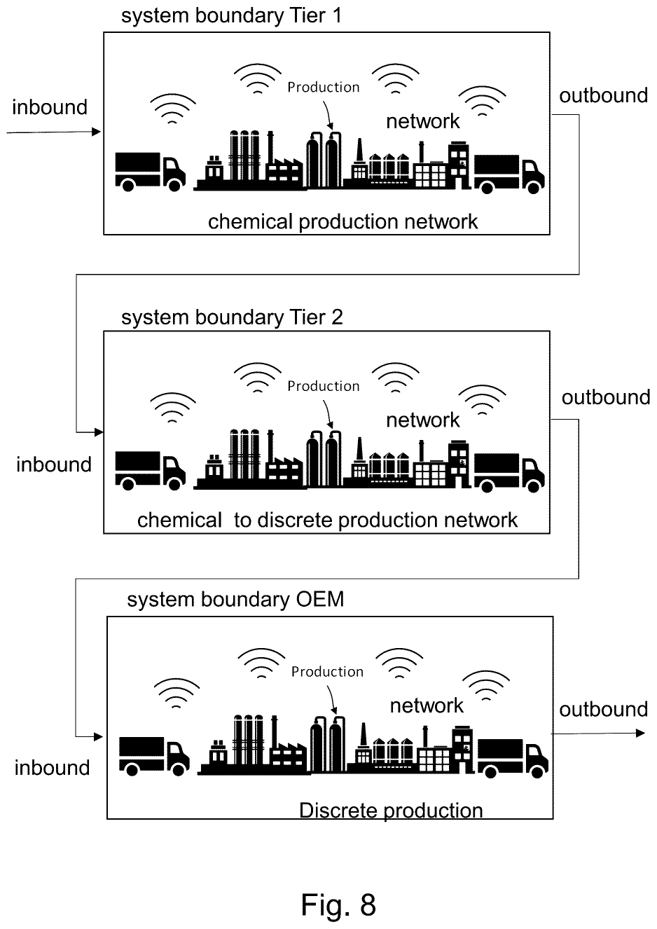

FIG. 8 illustrate an example of a method for producing at least one output material associated with at least one environmental attribute in a supply chain.

The example of FIG. 8 illustrates two tiers and an original equipment manufacturer. Tier 1 may be a chemical producer operating the chemical production network. The chemical production network may be associated with a system boundary. The system boundary may signify the physical boundary of the chemical production network. The input material(s) entering the chemical production network at any stage of the production network or the system boundary of the chemical production network may signify entry points to the chemical production network. On entry of input material(s) associated with one or more environmental attributes the environmental attribute(s) may be decoupled from the physical material flow of the input material(s) through the chemical production network. Such separation of the physical input material and the virtual environmental attribute may be provided by the method for registering at least one input material associated with at least one environmental attribute as described herein and as for example illustrated in FIGS. 5a and 6 (inbound). Output material(s) may be produced from input material(s) by the chemical production network. At least one output material may be produced by the chemical production network and the output material may be linked to at least one environmental attribute as described herein and illustrated in FIGS. 5b and 7 (outbound).

The output material(s) associated with at least one environmental attribute as produced by the chemical production network may be provided to the next tier. In the illustrated example tier 2 may be a production network producing discrete products from output material(s) or chemical products. Discrete products may be any products associated with a distinct physical units.

Discrete manufacturing in contrast to process manufacturing use such discrete products to assemble other discrete products. Chemical production in contrast uses process manufacturing where input material(s) are mixed and chemically converted to chemical output product(s). Such output product(s) are output material(s) that may be transferred in discrete units, such as containers or wreath. The output material(s) are such are however no discrete product(s). The chemical to discrete production network may be associated with a system boundary as described above. Similar to the chemical production network the chemical to discrete production network may on inbound register input material(s) associated with at least one environmental attribute, which may be the output material(s) of the chemical production network as described herein or illustrated in FIGS. 5a and 6 (inbound). Discrete output product(s) may be produced by the chemical to discrete production network. At least one discrete output product may be linked to at least one environmental attribute (outbound).

The discrete product(s) associated with at least one environmental attribute as produced by the chemical to discrete production network may be provided to an original equipment manufacturer producing end products. As described herein and in the context of FIGS. 5a and 6, the discrete product(s) and associated environmental attribute(s) may be decoupled on registration (inbound). As described herein and illustrated in FIGS. 5b and 7 after decoupling the environmental attribute may be linked to the end product (outbound).

This way the environmental attributes associated with any input material(s) may be tracked through the value chain up to the end product. The methods, apparatuses and systems described herein enable transparency from early stages of the value chain on chemical product level to end stage of the value chain on end product level. Through linking of physical material and environmental attribute environmentally friendly products and more sustainable production can be made transparent and tracked.

1. A computer-implemented method for registering at least one input material associated with at least one environmental attribute, wherein the input material is used in a chemical production network deriving one or more output material(s) from the input material, the method comprising:
providing an input material to the chemical production network,
providing at least one input material identifier associated with the respective input material, at least one environmental attribute associated with the respective input material and an quantity of input material provided to the chemical production network, and
based the quantity of input material allocating the environmental attribute to an input material account associated with the respective environmental attribute.

2. The method of claim 1, wherein upon allocating the environmental attribute to the input material account the environmental attribute is decoupled from the physical flow of input material(s) for production of the output material by the chemical production network.

3. The method of claim 1, wherein the input material identifier is associated with the physical entity of the input material entering the chemical production network.

4. The method of claim 1, wherein the at least one input material identifier, the at least one environmental attribute associated with the respective input material identifier and the quantity of input material are provided on entry of the input material to the chemical production network.

5. The method of claim 1, wherein providing the quantity of input material includes providing a measured quantity of input material fed into a material storage or fed into a plant of the chemical production network for producing one or more output material(s) from the input material(s).

6. The method of claim 1, wherein the material identifier relates to a LOT number assigned to a certain quantity or group of input material(s) and/or the material identifier relates to an order number assigned to the transfer of a certain quantity or group of input material(s) for the chemical production network.

7. The method of claim 1, wherein the input material identifier is associated with a certificate certifying the environmental attribute.

8. The method of claim 1, wherein the at least one environmental attribute and the quantity of input material provided to the chemical production network are associated with the input material identifier and authentication information.

9. The method of claim 1, wherein providing the input material to the chemical production network triggers generation of a transaction record assigning the input material identifier from an input material producer identifier to an input material consumer identifier.

10. A method for producing at least one output material associated with at least one environmental attribute, wherein the output material is produced by a chemical production network from one or more input material(s), the method comprising:
producing the output material at least in part from the one or more input material(s),
providing the output material identifier associated with the produced output material,
linking one or more environmental attributes from the at least one input material account associated with the respective environmental attribute to the output material identifier, wherein the input material account is associated with the respective environmental attribute and holds environmental attributes, which are allocated to the input material account based on input material provided to the chemical production network, and
providing the output material associated with at least one environmental attribute.

11. The method of claim 10, wherein the environmental attribute linked to the output identifier is decoupled from the physical flow of input material(s) for production of the output material by the chemical production network.

12. The method of claim 10, wherein the environmental attribute(s) linked to the output material identifier are determined based on the number of environmental attribute(s) linked to the one or more input material(s) used for producing the output material.

13. The method of claim 10, wherein the output material associated with the output material identifier is provided physically and the at least one output environmental attribute associated with the output material identifier is provided virtually.

14. The method of claim 10, wherein the at least one environmental attribute associated with the output material identifier is provided as decentral asset including a decentral identifier, cryptographic information and the at least one output environmental attribute.

15. An apparatus configured to register at least one input material associated with at least one environmental attribute, wherein the input material is used in a chemical production network deriving one or more output material(s) from the input material, the apparatus comprising:
a material provider configured to provide an input material to the chemical production network,
an identifier provider configured to provide at least one input material identifier associated with the respective input material, at least one environmental attribute associated with the respective input material and an quantity of input material provided to the chemical production network, and
an inbound allocator configured to allocate based the quantity of input material the environmental attribute to an input material account associated with the respective environmental attribute.

16. An apparatus configured to produce at least one output material associated with at least one environmental attribute, wherein the output material is produced by a chemical production network from one or more input material(s), the apparatus comprising:
a chemical production network configured to produce the output material at least in part from the one or more input material(s),
a identifier provider configured to provide an output material identifier associated with the produced output material,
a linker configured to link one or more environmental attributes from the at least one input material account associated with the respective environmental attribute to the output material identifier, wherein the input material account is associated with the respective environmental attribute and holds environmental attributes, which are allocated to the input material account based on input material provided to the chemical production network, and
a material provider configured to provide the output material associated with at least one environmental attribute.
